(19) United States
(12) Patent Application Publication
(10) Pub. No.: US 2004/0259578 A1
(43) Pub. Date: Dec. 23, 2004

(54) Apparatus and associated method, for storing multiple synchronization identifier information at a mobile station of a radio communication system

(76) Inventors: George Cherian, San Diego, CA (US); Rey Nicolas, San Carlos, CA (US)

Correspondence Address: Robert H. Kelly, Scheef & Stone, L.L.P., Suite 1400, 5956 Sherry Lane, Dallas, TX, 75225, US

(21) Appl. No.: 10/850,174

(22) Filed: May 20, 2004

Related U.S. Application Data
(60) Provisional application No. 60/480,459, filed on Jun. 21, 2003.

(51) Int. Cl. H04Q 7/20; H04B 7/00

(52) U.S. Cl. 455/502; 370/350; 455/515

(57) ABSTRACT

Apparatus, and an associated method, for facilitating call set-up procedures to permit effectuation of a selected communication service. Storage locations are maintained at a mobile station at which synchronization identification indicia is stored. When a call connection is to be formed to effectuate a selected communication service, associated synchronization indication indicia is retrieved from the storage locations and used pursuant to the call set-up procedures.

### CROSS-REFERENCE TO RELATED APPLICATIONS

The present invention claims the priority of U.S. Provisional Patent Application, Ser. No. 60/480,459, filed on Jun. 21, 2003, the contents of which are incorporated herein by reference.

The present invention relates generally to the effectuation of communication services in a radio communication system, such as a cellular communication system operable pursuant to a third-generation, code-division, multiple-access communication scheme. More particularly, the present invention relates to apparatus, and an associated method, by which to maintain, and selectably to utilize, synchronization identifier information associated with a plurality of service configurations. The synchronization identifier information is used pursuant to call set-up procedures required to permit effectuation of a corresponding plurality of communication services.

Use of stored synchronization identifier information pursuant to call set-up procedures obviates the need to perform a time-consuming service negotiation to negotiate, and to obtain, the needed synchronization identification information. Reduced amounts of time are required for call set-up procedures, thereby improving communication performance with respect to effectuation of the communication services associated with the synchronization identifier information.

### BACKGROUND OF THE INVENTION

Ready availability of communication systems through which to communicate is a practical necessity for many in modern society. Data is communicated during operation of a communication system between a set of communication stations. At least one of the communication stations forms a sending station. And, at least another of the communication stations forms a receiving station.

Data originated at a sending station is communicated by way of a communication channel for delivery to a receiving station. The receiving station detects delivery of the data sent thereto. And, the receiving station recovers the informational content of the received data.

Many types of communication systems, with differing constructions and capabilities, provide for the effectuation of various types of communication services. And, advancements in communication technologies have permitted, and continue to permit, the development and deployment of new types of communication systems that provide for new types of communication services.

A radio communication system is an exemplary type of communication system. In a radio communication system, a radio channel interconnects the sending and receiving stations. A radio channel is defined upon a radio link extending between the communication stations. In contrast, wireline communication systems define communication channels upon wireline connections that interconnect the sending and receiving stations. That is to say, in a wireline communication system, a wireline is required to be positioned to interconnect the sending and receiving stations. Communications in a wireline communication system, as a result, are limited to be between communication stations positioned at locations that are permitting of their interconnection by way of the wireline. As a radio communication system is free of the need to interconnect the communication stations operable therein by way of wirelines, communications are effectuable in a radio communication system by way of communication stations positioned at locations from which communications would not be permitted by way of a wireline communication system. Radio communication systems thereby are able to provide increased communication availability in contrast to their wireline counterparts. Additionally, radio communication systems are implementable as mobile communication systems in which one, or more of the communication stations operable therein is provided with communication mobility.

A cellular communication system is an exemplary type of radio communication system. The network infrastructures of various constructions of cellular communication systems have been installed to encompass significant portions of the populated areas of the world. And, cellular communication systems are regularly utilized to effectuate telephonic communications in areas encompassed by the communication systems.

Successive generations of cellular communication systems have been developed and deployed. So-called first generation communication systems generally relied upon analog communication techniques. So-called second generation cellular communication systems utilize digital communication techniques and provide for fixed-rate data communication services. Third-generation and new-generation cellular communication systems also utilize digital communication techniques and provide for variable-rate data communication services. A 3GPP2 (third generation partnership project 2) operating specification is undergoing standardization and pertains, generally, to a new-generation cellular communication system that utilizes code-division multiple-access communication techniques.

A communication system constructed to be operable in conformity with the 3GPP2 operating specification, as presently promulgated, sets forth various call procedures associated with formation of a communication session during which to effectuate a communication service. Various communication services require various communication resources. And, identification and allocation of the communication resources to effectuate a selected communication service is made during a service negotiation, performed, for instance, pursuant to call set-up procedures. As service negotiation requires both time and signaling overhead, the need to obtain a new service configuration and its associated synchronization identifier information results in communication delay and increased processing requirements.

An existing proposal for inclusion in the 3GPP2 operating specification provides a mobile station with the capability of storing a last-used service configuration and a corresponding synchronization identifier, i.e., a SYNC_ID value. By storing the last-used service configuration information at the mobile station, when the same type of call is originated or received during the immediately-succeeding communication session, reduced call set-up times are permitted as a new service negotiation need not again be performed.

While storage of the last-used service configuration advantageously reduces call set-up times in the immediately-subsequent communication session, when the same communication service is to be effectuated, if another type of communication service is to be effectuated, a new service negotiation is still required.

If a manner could be provided by which to obviate the need for a service negotiation when a communication service to be effectuated with the mobile station just-prior performed communication service, analogous time and processing savings would result.

It is in light of this background information related to effectuation of communication services in a radio communication system that the significant improvements of the present invention have evolved.

### SUMMARY OF THE INVENTION

The present invention, accordingly, advantageously provides apparatus, and an associated method, for facilitating effectuation of communication services in a radio communication system, such as a cellular communication system operable to a third-generation, code-division, multiple-access communication scheme, e.g., a 3GPP2-defined communication scheme.

Through operation of an embodiment of the present invention, a manner is provided by which to maintain, and selectably to utilize, synchronization identifier information associated with a plurality of service configurations.

Synchronization identification information is used pursuant to call set-up procedures that are required to permit effectuation of a corresponding plurality of communication services. The stored synchronization identifier information associated with the plurality of service configurations is accessible during call set-up procedures. The information corresponds to the information that would otherwise be obtained pursuant to a service negotiation. Stored synchronization identifier information, rather than newly-negotiated information, is utilized. The stored information obviates the need otherwise to perform a time-consuming service negotiation again to negotiate and to obtain the needed synchronization identification information to permit effectuation of a selected communication service. And, as a result, reduced amounts of time are required pursuant to call set-up procedures.

In one aspect of the present invention, storage locations are formed at the mobile station for storing a plurality of synchronization identifier indicia formed of first and at least second synchronization identifier indicia. The storage locations are selectably accessible during operation of the mobile station to retrieve the values of the indicia stored thereat to be used pursuant to call set-up procedures without the need to perform service negotiations to obtain the information.

The number of synchronization identifier indicia stored at the mobile station is, in part, dependent upon the maximum number of synchronization identifiers that are supportable by the mobile station and the network part of the communication system in which the mobile station is operable. The base station sends its capability to the mobile station in an extended system parameter message. And, the mobile station sends its capability to the base station of the network part alternately by way of an origination message, a registration message, or a page response message, as appropriate. The base station, in the exemplary implementation, sends the extended system parameter message responsive to delivery of any of the origination, registration, or page response messages to the base station of the network part.

The indicia stored at the storage locations is updatable, thereby to be changeable. Flexibility is provided as, when additional services are offered and available in the cellular communication system, synchronization identifier indicia associated with such additional service is storable at the storage locations of the mobile station.

In another aspect of the present invention, the synchronization identifiers are associated with SID/NID (system identification/network identification) pairs. Thereby, in the event that the mobile station is positioned at a location encompassed by a system having a separate SID or NID value, the mobile station is able to access a synchronization identifier associated with the system in whose coverage area that the mobile station is positioned. And, in one implementation, if the mobile station has not been positioned within an area encompassed by a system identified by a particular SID/NID, the indicia associated with the synchronization identifiers of the identified SID/NID are deleted, increasing the flexibility of management of memory resources.

In the exemplary implementation, the mobile station is operable in conformity with an IS2000 REL C operating specification that defines a cellular communication system that utilizes a code-division, multiple-access communication scheme. The mobile station is capable of storing a plurality of SYNC_ID values, each associated with an SID/NID pair. New variables are defined and used in new messages, including an extended system parameter message that is sent by a base station of the network part of the communication system to the mobile station. Values of the new variables are utilized at the mobile station to decide how many synchronization identifiers are to be stored at the mobile station, subsequently to be used pursuant to call set-up procedures to form communication connections permitting the effectuation of selected communication services.

Further, pursuant to the exemplary implementation, the SYNC_ID values form one or more lists that are maintained pursuant to a rules-based maintenance scheme. The rules provide a manner by which to maintain currency of SYNC_ID values at the mobile station.

Because additional synchronization identifiers that provide necessary configuration information is retrieved from the storage locations at the mobile station without need for a service negotiation. Thereby, time-savings and processing-savings result.

In these and other aspects, therefore, apparatus, and an associated method, is provided for a radio communication system. The radio communication system has a network part and a mobile station. The network part and the mobile station are selectably operable to communicate data therebetween during a communication session to effectuate communication services of a plurality of communication-service types. Call set-up is facilitated to form communication connections between the mobile station and the network part to permit effectuation of the communication services. A first storage location is embodied at the mobile station. The first storage location stores first synchronization identifier indicia that is used pursuant to call set-up to form the communication connections to permit effectuation of a first communication service of a first communication service type. At least a second storage location is embodied at the mobile station. The at least the second storage location stores at least second synchronization identifier indicia that is used pursuant to call set-up to form the communication connections to permit the effectuation of at least a second communication service of at least a second communication service type.

### BRIEF DESCRIPTION OF THE DRAWINGS

FIG. 1 illustrates a functional block diagram of an exemplary radio communication system in which an embodiment of the present invention is operable.

FIG. 2 illustrates a message sequence diagram representative of exemplary signaling generated during operation of the radio communication shown in FIG. 1.

FIG. 3 illustrates the format of an exemplary registration message generated pursuant to operation of an embodiment of the present invention.

FIG. 4 illustrates the format of an exemplary origination message generated during operation of an embodiment of the present invention.

FIG. 5 illustrates the format of an exemplary page registration message generated during operation of an embodiment of the present invention.

FIG. 6 illustrates the format of an extended system parameters message generated during operation of an embodiment of the present invention.

FIG. 7 illustrates a method flow diagram listing the method of operation of an embodiment of the present invention.

### DETAILED DESCRIPTION

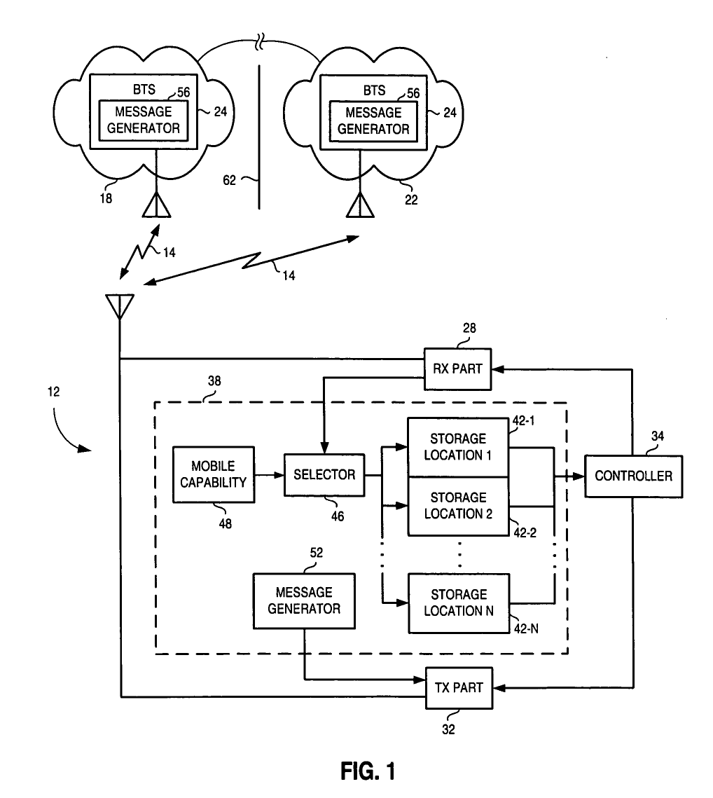

Referring first to FIG. 1, a radio communication system, shown generally at 10, provides for radio communications with mobile stations, of which the mobile station 12 is exemplary. Data is communicated between a network part of the communication system and the mobile station by way of radio channels defined upon radio links extending between the network part and the mobile station. Data originated at the network part is communicated pursuant to effectuation of a communication service to the mobile station by way of forward link channels defined upon the radio link. And, data originated at the mobile station is communicated pursuant to effectuation of a communication service by way of reverse link channels defined upon the radio link. Here, the arrow 14 is representative of radio links upon which forward and reverse link channels are defined.

In the exemplary implementation, the radio communication system forms a cellular communication system operable generally pursuant to a CDMA (code-division, multiple-access) cellular communication system defined by an IS2000 REL C operating specification. While the following description shall describe exemplary operation of the radio communication system in terms of its implementation as a cellular communication system operable generally pursuant to the IS2000 REL C operating specification, teachings of the present invention are analogously also implementable in radio communication systems that are operable in other manners. Operation of an embodiment of the present invention implemented in a radio communication system of another type is analogous to that described below with respect to its implementation in the IS2000 REL C—compliant system.

Various types of communication services, requiring varying communication resources and service configurations, are effectuable during operation of the radio communication system. The service configurations correspond to a synchronization identifier, SYNC_ID. The service configuration is derived pursuant to a service negotiation performed, e.g., during call set-up procedures prior to commencement of effectuation of the communication service. The service negotiation requires overhead signaling, necessitating computational operations both at the network part and at the mobile station and time delays to negotiate the service configuration. While the existing IS2000 REL C sets forth a manner by which the mobile station stores a last-used service configuration and corresponding synchronization identifier, SYNC_ID, to obviate the need to perform a service negotiation when a newly-requested communication service corresponds to a last-performed communication service. Instead, the last-used service configuration is retrieved and reused to perform the subsequent communication service. However, in the event that the newly-requested communication service differs from the last-performed communication service, the stored service configuration and the service configuration required for the newly-requested communication service differ. And, an attendant service negotiation is required.

An embodiment of the present invention provides a manner by which to store, and maintain, and subsequently utilize synchronization identifiers and corresponding service configurations associated with a plurality of communication services to permit their use pursuant to call set-up procedures to increase the likelihood that call set-up procedures can be performed without resort to service negotiations.

In the illustration of the figure, the network part of the communication system includes a first network 18 and a second network 22. The networks are operated, for instance, by separate network operators, and are interconnected by conventional network mechanisms (not shown). The network 18 is identified by a first SID/NID (system identifier/network identifier) value. And, the network 22 is identified by a second SID/NID value. The separate networks define, here, separate coverage areas. When mobile stations are positioned within the coverage area of the first network 18, the mobile stations generally communicate with the first network. And, when the mobile stations are positioned within the coverage area of the second communication network, the mobile stations generally communicate with the second communication network.

The networks 18 and 22 each include a plurality of base stations (BTSs) 24, of which a single base station 24 at each of the networks 18 and 22 is shown in the figure. The base stations include radio transceiver circuitry permitting communication with mobile stations within the coverage areas of the individual ones of the base stations. The coverage areas of the base stations of each of the networks collectively define the coverage areas of the respective networks. The mobile stations also include radio transceiver circuitry. The radio transceiver circuitry of the mobile station 12 is represented by a receive part 28 and a transmit part 32. The receive part detects and operates upon data delivered to the mobile station by the network part. And, the transmit part transmits data for communication upon reverse link channels for delivery to the network part of the communication system.

The mobile station also includes a controller 34 operable, amongst other things, to control operation of the mobile station. And, the mobile station further includes apparatus 38 of an embodiment of the present invention. The elements shown form portions of the apparatus 38 are functionally represented, implementable in any desired manner, such as by algorithms executable by processing circuitry. And, while the controller 34 and apparatus 38 are separately represented, in one implementation, the functions performed during operation of the apparatus 38 are carried out by the controller 34.

The apparatus operates to store a plurality of SYNC_IDs and associated service parameters at a plurality of storage locations 42. Here, N storage locations, storage locations 42-1, 42-2 . . . 42-N are shown in the figure. Selection of how many and what values are to populate the storage locations 42 is made by a selector 46. The selector 46 is coupled to receive part 28 and to a mobile station capacity value indicator 48. In the exemplary implementation, the selector operates to select the number of SYNC_ID and associated service configuration values in the storage locations 42 based upon network capabilities, indications of which are sent to the mobile station and received by the receive part 28, as well as mobile station capabilities identified by the element 48. Values stored at the storage locations 42 are selectably retrievable by the controller 34 pursuant to call set-up procedures and used by the receive and transmit parts of the mobile station pursuant to formation of appropriate call connections to permit effectuation of a selected communication service. The values together define a list.

Further pursuant to operation of an embodiment of the present invention, the apparatus 38 includes a capability indication message generator 52. The capability indication message generator 52 generates capability indication messages containing variable values to indicate the mobile station capabilities with respect, for instance, to the storage locations and the synchronization identifier and corresponding service configuration information storable thereat. Messages generated by the generator are provided to the transmit part 32 and caused to be transmitted therefrom upon a reverse link back to the network part. In one implementation, the capability indication message generator generates a value that is inserted into a page response message, an origination message, or a registration message that is otherwise communicated during normal operation of the mobile station.

The base stations 24 include further apparatus 38 of an embodiment of the present invention. The apparatus 38 embodied at the base stations here include an extended system parameter message generator 56. The message generator 56 operates to generate an extended system parameter message for communication to the mobile stations, such as the mobile station 12, to identify network capabilities with respect to synchronization identifiers and corresponding service configurations. Messages generated both by the network part and by the mobile station identify to each other the capabilities of the respective portions of the communication system. And, therefrom, the selector 46 selects the selected number of SYNC_IDs and associated service parameters at the storage location 42. And, through their subsequent retrieval, call set-up times are reduced as the need to perform service negotiations to obtain the parameter values is reduced. Updating of, addition to, and deletion of values stored at the storage locations facilitate flexible operation of the mobile station. With subsequent changes in communication technologies, and the introduction of new communication services, appropriate identification of their identifiers and associated service configurations are stored at the storage locations. And, by permitting the base station 24, through generation of the extended system parameter messages by the generators 56, to identify the maximum number of SYNC_IDs that the network part supports, the mobile station is able more efficiently to use its storage locations to store only the SYNC_IDs and associated service parameters that the network supports.

Pursuant to a further embodiment of the present invention, the SYNC_IDs are associated with SID/NID pairs that identify the different networks, here networks 18 and 22 of the network part. Through this additional association, users of mobile stations that are positioned proximate to borders, such as the border 62 between the networks 18 and 22. The IS2000 REL 3 operating specification specifies that a mobile station set a value of SYNC_ID to null if the mobile station moves between different systems or sub-networks. Here, if the mobile station moves between networks or systems defined by different SID/NID pairs, the mobile station is susceptible to originate and to release calls separately with the separate networks. By using the further association of an embodiment of the present invention, operations are performed at the mobile station to look up a SYNC_ID stored at a storage location and associated service parameters and perform fast call set-up more frequently. Additionally, pursuant to a further embodiment of the present invention, through the association of the SYNC_ID list with SID/NID pairs, here, e.g., SID_NID_LISTs, additional flexibility in memory resource management is provided. The mobile station need not maintain a SYNC_ID list entry for systems or networks that the mobile station has not visited, i.e., been in communication connectivity with, for a selected time period.

Pursuant to operation of an embodiment of the present invention, new variables are defined. A variable MAX_SYNC_ID_NUMs identifies a maximum number of synchronization identifiers that are possible, e.g., in a particular system or network. A DS_SYNC_ID_NUMr defines a maximum number of synchronization identifiers that a base station is able to support. And, a MOB_SYNC_ID_NUMp identifies a maximum number of synchronization identifiers that a mobile station is capable of per an SID/NID pair. And, an SYNC_ID_LISTs identifies a list of synchronization identifiers stored by the mobile station per SID/NID pair, up to a maximum of MAX_SYNC_ID_NUMs.

In the exemplary implementation, the extended system parameter message generated by the generator 56 includes a value of the BS_SYNC_ID_NUMr that the base station from which the message is transmitted is able to support. Upon delivery of the message at the mobile station, indications are provided to the selector, and the selector sets a value of the MAX_SYNC_ID_NUMs as the min (MAX_SYNC_ID_NUMr, MOB_SYNC_ID_NUMp).

The mobile station generates a capability information message that includes a value of the mobile station capability, e.g., a value of the MOB_SYNC_ID_NUMp. The value of the parameter forms a portion of a registration message, an origination message, and a page response message, thereby timely to identify to the base station how many synchronization identifiers that the mobile station is able to support. If the mobile station is unable to support any synchronization identifiers, the value is set to be zero.

Further pursuant to operation of an embodiment of the present invention, the mobile station, upon successful establishment of a call, i.e., service, connection, stores the synchronization identifier associated with the current service configuration in the storage locations to form an SYNC_ID_LIST. The storage and maintenance is made according to a rules-based mechanism.

In the exemplary implementation, the mobile station attaches the synchronization identifier to the SYNC_ID_LIST associated with the SID/NID list here at the head of the SYNC_ID_LIST. If the size of the list corresponds to the value of the MAX_SYNC_ID_NUMs, then the final SYNC_ID in the list is deleted, and the current SYNC_ID value is added to the head of the list, i.e., the first storage location. If the current SYNC_ID is already contained in the list, then the position of the SYNC_ID is moved to be at the top of the list, at the first storage location of the storage locations.

Pursuant to an exemplary implementation, if an SID/NID pair is considered to be invalid, SYNC_IDs, or lists formed therefrom, are correspondingly considered to be invalid. And, pursuant to the exemplary implementation, the base station also is capable of storing synchronization identifiers of the same number, ascertained in the same manner, as the minimum expression associated with the manner by which the mobile station selects the number of synchronization identifiers to be stored.

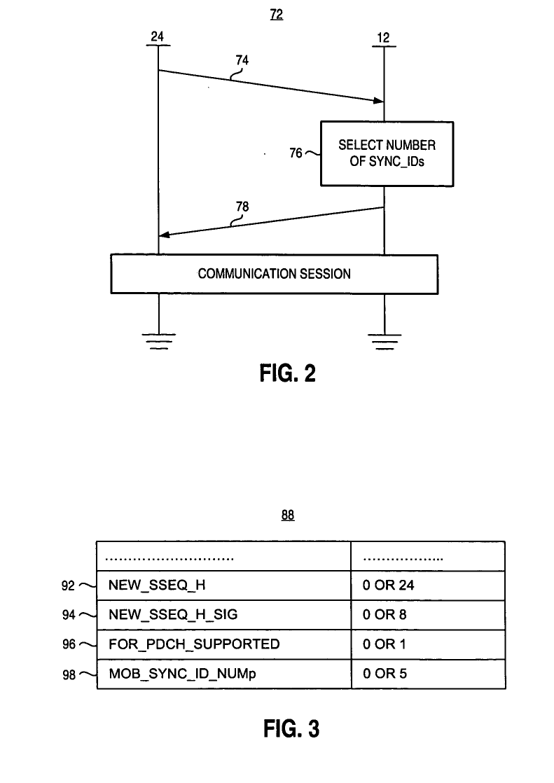

FIG. 2 illustrates a message sequence diagram shown generally at 72, representative of signaling generated during operation of the radio communication system 10 shown in FIG. 1. Here, signaling between a selected base station 24 and the mobile station 12 is represented. The base station sends a message, an extended system parameter message 74, to the mobile station to alert the mobile station of the base station capabilities with respect to synchronization identifiers.

Once delivered to the mobile station, the mobile station selects, as indicated by the block 76, the number of synchronization identifiers that are to be stored at the mobile station. Selection is made, in part, responsive to the values contained in the message 74. Subsequently, and as indicated by the segment 78, the mobile station generates a registration, an origination, or a page response message during its operation. The message that is sent, indicated by the segment 78, identifies to the base station the mobile station capabilities.

Thereafter, and as indicated by the block 82, a communication session is created by a service connection between the base station and the mobile station. The session, once formed, permits the effectuation of a selected communication service. The service connection utilizes the service configuration identified by the synchronization identifiers and associated information stored at the mobile station without need for a service negotiation to form the service connection.

FIG. 3 illustrates the format of an exemplary registration message, here identified at 88, formed pursuant to an embodiment of the present invention. The registration message includes four fields, fields 92, 94, 96, and 98 of bit links identified in the figure. The field 98 contains a value of the MOB_SYNC_ID_NUMp parameter.

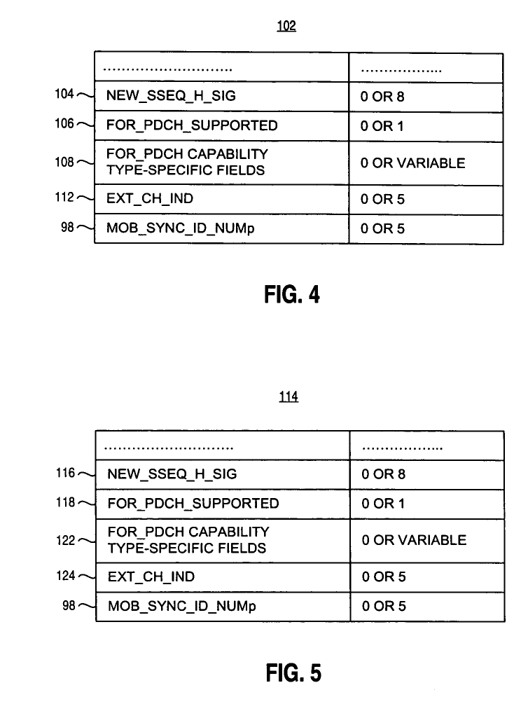

FIG. 4 illustrates an exemplary origination message, here identified at 102. The origination message includes fields 104, 106, 108, 112, and 98. The field 98 is formed of values of the MOB_SYNC_ID_NUMp value.

FIG. 5 illustrates an exemplary page response message, here identified at 114, formed pursuant to an embodiment of the present invention. The page response message is formed of fields 116, 118, 122, 124, and here also 98.

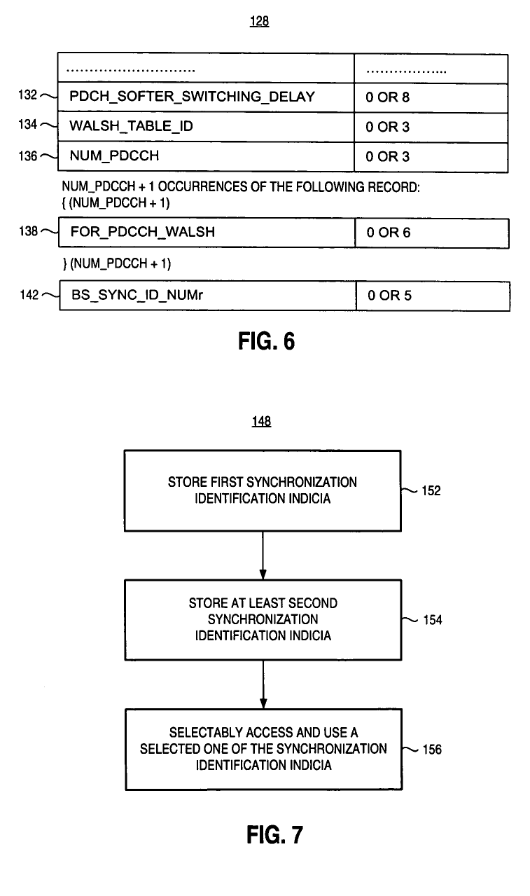

FIG. 6 illustrates an extended system parameters message, here identified at 128, also formed pursuant to operation of an embodiment of the present invention. The message includes fields 132, 134, 136, and, selectably, fields 138 and 142. The field 142 is populated with values of a DS_SYNC_ID_NUMr value.

FIG. 7 illustrates a method flow diagram, shown generally at 148, representative of the method of operation of an embodiment of the present invention. The method facilitates call set-up to form communication connections between a mobile station and the network part of a radio communication system to permit effectuation of a communication service therebetween.

First, and as indicated by the block 152, first synchronization identifier indicia that is used pursuant to call set-up to form the communication connection to permit effectuation of a first communication service of a first communication-service type is stored at a first storage location. And, as indicated by the block 154, at least second identifier indicia that is used pursuant to call set-up to form the communication connections to permit effectuation of at least a second communication service of at least a second communication service type is stored at at least a second storage location.

Thereafter, and as indicated by the block 156, a selected one of the identification indicia is selectably accessed and used pursuant to call connection procedures.

What is claimed is:

1. In a radio communication system having a network part and a mobile station, the network part and the mobile station selectably operable to communicate data therebetween during a communication session to effectuate communication services of a plurality of communication-service types, an improvement of apparatus for facilitating call set-up to form communication connections between the mobile station and the network part to permit effectuation of the communication services, said apparatus comprising:
a first storage location embodied at the mobile station, said first storage location for storing first synchronization identifier indicia that is used pursuant to call set-up to form the communication connections to permit effectuation of a first communication service of a first communication-service type;
at least a second storage location embodied at the mobile station, said at least second storage location for storing at least second synchronization identifier indicia that is used pursuant to call set-up to form the communication connections to permit effectuation of at least a second communication service of at least a second communication-service type.

2. The apparatus of claim 1 further comprising a selector embodied at the mobile station, said selector for selecting synchronization identifier indicia for storage at said first storage location and said at least second storage location, said at least second storage location comprising said second storage location and at least a third storage location when said selector selects first, second, and at least third synchronization identifier indicia, the third synchronization identifier indicia stored at said third storage location.

3. The apparatus of claim 2 wherein said selector is adapted to receive indications, generated by the network part, that specify how many synchronization identifier indicia are to be stored at the mobile station and wherein selection made by said selector is made, at least in part, responsive to the indications received from the network part.

4. The apparatus of claim 3 wherein the radio communication system comprises a cellular communication system operable pursuant to a code-division, multiple-access communication scheme that defines selected synchronization identifiers associated with selected service configurations, individual ones of the service configurations associated with corresponding individual ones of the communication service types, and wherein the first and at least second synchronization-identifier indicia stored at said first and at least second storage locations, respectively, comprise the selected synchronization identifiers.

5. The apparatus of claim 4 wherein the selected synchronization identifiers defined in the cellular communication system and associated with the selected service configurations further have service parameters indexed together therewith and wherein said first storage location and said at least second storage location further store the service parameters indexed together with the first and at least second synchronization identifier indicia, respectively.

6. The apparatus of claim 3 further comprising an extended system parameter message generator embodied at the network part, said extended system parameter message generator for generating an extended system parameter message, the extended system parameter message containing the indications that specify how many synchronization identifier indicia are to be stored at the mobile station, the extended system parameter message for delivery to the mobile station and said selector embodied thereat.

7. The apparatus of claim 6 wherein the mobile station further comprises a capability indication message generator for generating a capability-indication message, the capability indication message identifying mobile station capability to store synchronization identifier indicia, the capability indication message for communication to the network part.

8. The apparatus of claim 7 wherein the extended system parameter message is generated responsive to delivery at the network part of the capability indication message generated by said capability indication message generator.

9. The apparatus of claim 7 wherein the mobile station registers with the network part and wherein the capability indication message comprises a part of a registration message generated pursuant to registration of the mobile station with the network part.

10. The apparatus of claim 7 wherein the mobile station sends an origination request to initiate the communication session and wherein the capability indication message comprises part of the origination request.

11. The apparatus of claim 7 wherein the mobile station generates a page response message to respond to a network page sent thereto and wherein the capability indication message comprises part of the page response message.

12. The apparatus of claim 7 wherein the capability indication message comprises a value identifying a maximum allowable number of synchronization identification indicia of which the mobile station is capable of storing.

13. The apparatus of claim 12 wherein the extended system parameter message generator comprises a value identifying a maximum allowable number of synchronization identification indicia supportable by the network part.

14. The apparatus of claim 13 wherein the mobile station stores first and at least second synchronization identifier indicia of a number corresponding to a lesser of the value included in the extended system parameter message and the value included in the capability indication message.

15. In a method of communicating in a radio communication system having a network part and mobile station, the network part and the mobile station selectably operable to communicate data therebetween during a communication session to effectuate communication services of a plurality of communication-service types, an improvement of a method for facilitating call set-up to form communication connections between the mobile station and the network part to permit effectuation of the communication services, said method comprising:
storing, at the mobile station, first synchronization identifier indicia that is used pursuant to call set-up to form the communication connection to permit effectuation of a first communication service of a first communication-service type;
storing, at the mobile station, at least second identifier indicia that is used pursuant to call set-up to form the communication connections to permit effectuation of at least a second communication service of at least a second communication service type; and
selectably accessing a selected one of the first and at least second identification indicia stored during said operations of storing pursuant to call set-up of a selected one of the first and at least second communication services.

16. The method of claim 15 further comprising the operation, prior to said operations of storing, of selecting how many identifier indicia to store at the mobile station.

17. The method of claim 16 wherein said operation of selecting further comprises the operation of comparing network-part capabilities with mobile-station capabilities.

18. The method of claim 17 further comprising the operation of sending, from the network part to the mobile station, a message identifying the network-part capabilities.

19. The method of claim 17 wherein selection made during said operation of selecting is of a number of identifier indicia associated with a lesser of a value of the network-part capabilities and the mobile-station capabilities.

20. The method of claim 15 wherein the radio communication system comprises a cellular communication system operable pursuant to a code-division, multiple-access communication scheme that defines selected synchronization identifiers associated with selected service configurations, individual ones of the service configurations associated with corresponding individual ones of the communication-service types, and wherein the first and at least second synchronization identifier indicia stored during said operations of storing comprise the selected synchronization identifiers.

21. Apparatus for a mobile station operable to communicate in a radio communication system with a fixed communication network to effectuate a selected communication service selected from amongst a plurality of communication services including a first communication service and at least a second communication service, said apparatus for facilitating formation of a service configuration to permit effectuation of the selected communication service, said apparatus comprising:
a mobile-station capability record indicator that indicates a selected number of service configuration indicia storable at the mobile station; and
a plurality of storage locations at least corresponding to the selected number of the service configuration indicia indicated by said mobile-station capability record indicator, said plurality of the storage locations for storing values representative of the selected number of the storage configuration indicia.

23. A method for facilitating formation of a selected service configuration between a mobile station and a fixed communication network of a radio communication system to permit effectuation of a selected communication service selected from amongst a plurality of communication services including a first communication service and at least a second service, said method comprising the operations of:
indicating a selected number of service configuration indicia storable at the mobile station; and
storing values representative of the selected number of the storage configuration indicia at a plurality of storage locations at the mobile station, the plurality of storage locations at least corresponding in number to the selected number of the service configuration indicia indicated during said operation of indicating.
